(19) United States
(12) Patent Application Publication
(10) Pub. No.: US 2015/0045098 A1
(43) Pub. Date: Feb. 12, 2015

(54) SYSTEM FOR PROVIDING ACCUMULATION-TYPE GAME SERVICE USING OFFLINE GOLF GAME

(71) Applicants: YoungJae Lim, Goyang-si (KR); SukHyun Kim, Goyang-si (KR); NamGyu Lim, Seoul (KR)

(72) Inventors: YoungJae Lim, Goyang-si (KR); SukHyun Kim, Goyang-si (KR); NamGyu Lim, Seoul (KR)

(21) Appl. No.: 14/233,353

(22) PCT Filed: Jul. 12, 2012
(86) PCT No.: PCT/KR2012/005545

§ 371 Date: Feb. 3, 2014

(30) Foreign Application Priority Data
Jul. 13, 2011 (KR) 10-2011-0069637

(51) Int. Cl. G07F 17/32; G07F 17/38

(52) U.S. Cl. CPC G07F 17/3258; G07F 17/3295; G07F 17/38
USPC 463/3

(57) ABSTRACT

The present invention relates to a system for providing an accumulation-type game service, and more specifically to a system for providing an accumulation-type game service using an offline golf game wherein: golfers playing an offline golf game at a country club, a screen golf game room, a par 3 hole, and the like participate in the accumulation-type game using an accumulation-type game device provided at each location before each golfer plays the golf game; and reserve money pre-assigned to each event are distributed to each golfer playing the offline golf game if events such as a hole-in-one, albatross, cycling birdie, eagle, and the like are achieved, thereby increasing interest in the golf game.

### TECHNICAL FIELD

The present invention relates to an accumulation-type game service system, and more particularly, to an accumulation-type game service system using an offline golf game capable of increasing interest in a golf game by participating in an accumulation-type game using an accumulation-type game console provided at each place before golfers who perform an offline golf game play the game at a country club, a screen golf game room, a par-three hole, or the like, and then, assigning a reserve money, which is previously allocated to each of events such as a hole-in-one, albatross, cycling birdie, eagle, and so on, in the golf game performed offline, to each golfer who performed the game.

### BACKGROUND ART

In recent years, as interest in golf is increased, golf driving ranges and screen golf game rooms are installed at many places so that peoples can easily enjoy golf without a lot of cost and time.

Accordingly, due to interest and attraction in a golf game itself, golf games of nine holes or eighteen holes are performed several times a day in many suburban country clubs and many urban screen golf game rooms.

In this way, golfers who frequently play golf games often make bets as to pay food expenses or game fees in order to increase interest in games.

However, since the betting between the golfers who play the golf game should make a result in the golf game, the golfers often focus to contend for victory. Accordingly, the golfer who is defeated in the game often feels bad, and monetary loss due to excessive betting becomes a considerable level, causing problems due to obsession about winning itself.

Accordingly, a new type game in which both of a winner or a loser can enjoy the golf game regardless of victory or defeat and all golfers can celebrate events such as a hole-in-one and so on is needed.

In addition, in a conventional golf game, since various golf games performed in the same place are individually performed and rewarded, the golf game is merely a one-time betting, the golfers are excessively obsessed for winning, and thus, interest in the golf game may be missed.

Further, in the conventional art, Korean Patent Laid-Open Publication No. 10-2006-0027396, entitled “Golf Business Method Using Wired or Wireless Internet or Ubiquitous, Operation System thereof, and Recording Medium thereof,” has proposed a conventional technique which focuses on only an operation of a golf game itself. However, even in the conventional art, only victory or defeat of the golf game performed between several golfers is focused.

Accordingly, in the conventional golf game, while the golfers play various games offline, results obtained by the various games are individually determined and individually rewarded. As a result, a new type game that can be applied to an offline golf game is needed such that the games can also be commonly applied between the golfers who participate in other golf games performed in a screen golf game room or a country club and the golfers can complete their skills and increase interest in the game.

### SUMMARY OF INVENTION

### Technical Problem

An object of the present invention is to provide an accumulation-type game service system using an offline golf game capable of increasing interest in a golf game by participating in an accumulation-type game using an accumulation-type game console provided at each place before golfers who perform an offline golf game play the game at a country club, a screen golf game room, a par-three hole, or the like, and then, assigning a reserve money, which is previously allocated to each of events such as a hole-in-one, albatross, cycling birdie, eagle, and so on, in the golf game performed offline, to each golfer who has performed the game.

### Solution to Problem

In order to achieve the aforementioned objects, there is provided an accumulation-type game service system using an offline golf game including: an accumulation-type game console installed at a place at which a golf game is performed and configured to issue a game certificate in which a user who wants to play an accumulation-type game is able to record a result of the golf game; an accumulated reserve money computation server connected to the accumulation-type game console on a communication network and configured to compute an accumulated value of reserve money accumulated through the accumulation-type game console by the user; a game certification management server configured to generate and transmit a serial number written in the game certificate issued from the accumulation-type game console, receive the result of the golf game performed offline, and determine whether events for payment of the reserve money occur; an accumulated reserve money calculation server configured to pay the reserve money accumulated in the accumulation-type game console and initialize the accumulated reserve money of the accumulation-type game console when the game certification management server determines that the events occur; and a game setting server configured to differentially set game events for payment of the reserve money and a ratio of the reserve money to be paid according to occurrence of the game events.

Here, the accumulation-type game console may include a game selection unit configured to select a golf game to be played by golfers; a reserve money reception unit configured to receive a small basic reserve money input according to a kind of golf game selected by the game selection unit; a golfer certification unit configured to receive personal information for individual certification of a golfer who plays the golf game; a game certificate issuance unit configured to issue a game certificate to which a serial number is applied such that the golfer who inputs the basic reserve money is able to write a result of the golf game performed offline; and an accumulation-type game server connection unit connected to an accumulation-type game server to form a communication path to transmit and receive data on the communication network.

In addition, the game certificate issuance unit may include a printer configured to print and output the game certificate in which a serial number of the accumulation-type game matched with the certification information of the golfer input through the golfer certification unit, a date and a time at which the golf game is performed, a kind of golf game selected by the game selection unit, certification information for certifying the golfer after that, and a result description box in which a result of the golf game and occurrence of events can be written are printed.

Further, the accumulated reserve money computation server may include a reserve money computation unit connected to the accumulation-type game server connection unit and configured to receive an input signal of a basic reserve money input into the reserve money reception unit on the communication network and update and store the reserve money accumulated in the accumulation-type game console; and a financial institution connection unit configured to transmit a sum of the reserve money accumulated in the accumulation-type game console to a financial institution and deposit the sum.

Furthermore, the game certification management server may include a serial number generation unit configured to generate a serial number capable of identifying a specific accumulation-type game performed through the golf game selected by the accumulation-type game console from another accumulation-type game performed by another golf game to transmit the serial number to the accumulation-type game console; and a game result reception unit configured to receive the result of the golf game written in the game certificate with the serial number and determine whether the events set by the accumulation-type game occur.

### Advantageous Effects of Invention

According to the present invention, interest in a golf game can be increased while reducing a gambling aspect such as golf betting, by putting small basic reserve money into a golf game performed offline and rewarding for events such as a hole-in-one or the like intermittently occurring during the golf game, regardless of victory or defeat of the golf game.

### BRIEF DESCRIPTION OF DRAWINGS

FIG. 1 is a system configuration view of an accumulation-type game service system using an offline golf game according to the present invention; and

FIG. 2 is a block diagram of the accumulation-type game service system using the offline golf game according to the present invention.

### DESCRIPTION OF EMBODIMENTS

Hereinafter, a specific embodiment of the present invention will be described in detail with reference to the accompanying drawings.

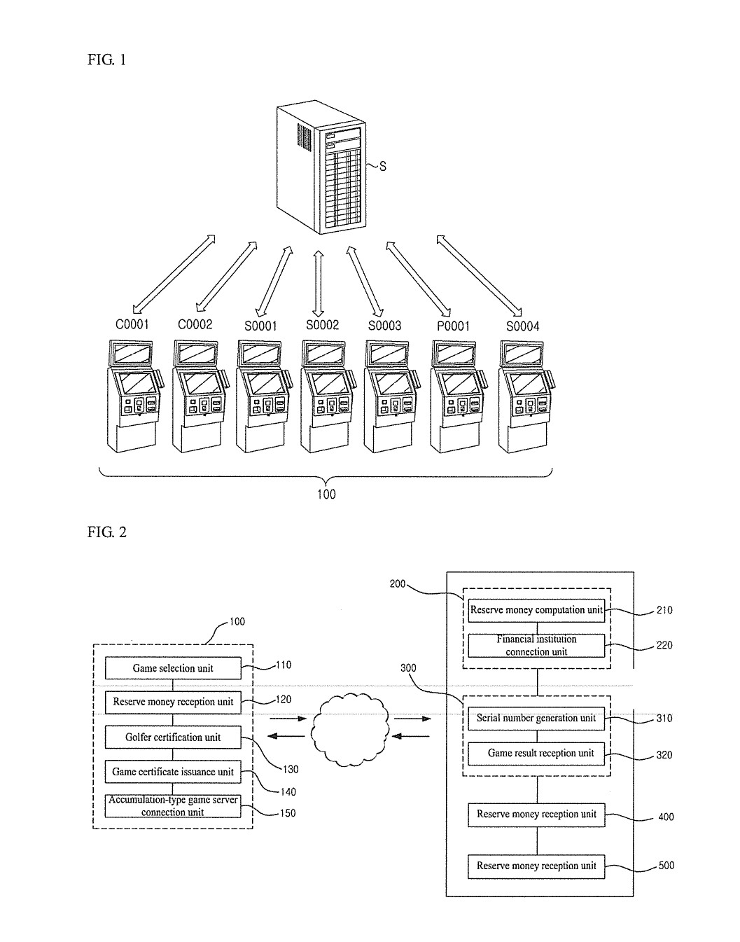

FIG. 1 is a system configuration view of an accumulation-type game service system using an offline golf game according to the present invention, and FIG. 2 is a block diagram of the accumulation-type game service system using the offline golf game according to the present invention.

Referring to FIGS. 1 and 2, the accumulation-type game service system using the offline golf game according to the present invention includes an accumulation-type game console 100 installed at a place at which a golf game is performed and configured to issue game certificates on which users who want to play an accumulation-type game can record results of the golf game, an accumulated reserve money computation server 200 connected to the accumulation-type game console on a communication network and configured to compute an accumulated value of reserve money accumulated through the accumulation-type game console by the users, a game certification management server 300 configured to generate and transmit a serial number written on the game certificate issued from the accumulation-type game console and receive the result of the golf game to determine whether an event occurs to pay the reserve money, an accumulated reserve money calculation server 400 configured to pay the reserve money accumulated in the accumulation-type game console to the user who is determined to make the event in the game certification management server and configured to initialize the accumulated reserve money of the accumulation-type game console, and a game setting server 500 configured to differentially set game events such as a hole-in-one and so on for paying the reserve money and ratios of the reserve money to be paid to the game events according to the events.

Here, the accumulation-type game consoles 100 are distributed and installed at a plurality of places at which golf games offline are performed, for example, screen golf game rooms or country clubs, and the accumulated reserve money computation server 200, the game certification management server 300, the accumulated reserve money calculation server 400, and the game setting server 500 are installed at an accumulation-type game server S, which is a main server serving as a service provider which provides an accumulation-type game service. In FIG. 1, the accumulation-type game consoles installed at the screen golf game room are designated by identification numbers such as S0001, S0002, S0003, and S0004. The accumulation-type game consoles installed at the country club are designated by identification numbers such as C0001, C0002, and so on, and the accumulation-type game consoles installed at a par-three hole are designated by identification numbers such as P0001 and so on.

In addition, the accumulation-type game consoles 100 (C0001, C0002, and so on) distributed and installed at many places are configured to be connected to the accumulation-type game server S via a communication network to transmit accumulated contents of a accumulation-type game user and receive information of the accumulated reserve money from the accumulation-type game server S to display the information.

The accumulation-type game console 100 includes a game selection unit 110 configured to select a golf game to be performed by golfers, a reserve money reception unit 120 configured to receive a small basic reserve money input according to a kind of the golf game selected by the game selection unit, a golfer certification unit 130 configured to receive personal information for individual certification of a golfer who plays the golf game, a game certificate issuance unit 140 configured to issue a game certificate, to which a serial number is given, so that the golfer who inputs the basic reserve money can write the result of the golf game performed offline, and an accumulation-type game server connection unit 150 connected to the accumulation-type game server to receive and transmit data on the communication network to form a communication path.

The game selection unit 110 includes a selection button configured to select whether the golf game to be performed at the screen golf game room or the country club is an individual game, in which two to four golfers play the game, or a team game, in which several groups play the game.

As described above, the game can be differentiated by inputting the basic reserve money to each individual or inputting the basic reserve money to each team playing the golf game according to the kind of game selected by the game selection unit 110.

In addition, as described above, the game certificate output from the game certificate issuance unit 140 according to the kind of golf game selected by the game selection unit 110 can be issued in a shape to be recorded appropriately for the golf game.

The reserve money reception unit 120 is configured to receive the small basic reserve money input by the golfers with respect to each golf game performed offline to store the reserve money in a separate storage space, match the input information of the stored basic reserve money with the serial number issued to the game certificate and the identification number of the accumulation-type game console, and transmit the matched information to the accumulated reserve money computation server 200 through the communication network.

Here, while the basic reserve money input into the reserve money reception unit 120 may be arbitrarily set, but in consideration of a subsidiary game for increasing interest in the game in addition to the golf game, which is a main game performed offline, the reserve money may be set to a small amount such as 1,000 Won (about $1) or 2,000 Won (about $2) to each golfer who participate in one golf game.

In addition, the golfer certification unit 130 is configured to input the reserve money through the reserve money reception unit, receive the certification information that can confirm the user who plays the golf game, and store the information with the serial number given to the game certificate. Here, the certification information that can confirm the user may be stored by inputting a resident registration number. However, the certification information is not limited thereto but various user certification means such as a mobile phone number or the like may be used as the certification information.

The game certificate issuance unit 140 includes a printer configured to print and output the game certificate in which a serial number of the accumulation-type game matched with the certification information of the golfer input through the golfer certification unit 130, a date and a time at which the golf game is performed, a kind of golf game selected through manipulation of the game selection unit by the golfer, certification information for certifying the golfer after that, and a result description box in which a result of the golf game and occurrence of events can be written are printed.

Here, the game certificate may further include a certificate signature box in which a user who plays the golf game writes the result of the golf game and signs his/her signature, and a caddie signature box in which a caddie who observes the golf game confirms the result of the golf game when the golf game is performed at the country club.

As described above, after the result of the golf game and the events occurring during the golf game such as a hole-in-one, albatross, or eagle are written on the game certificate output from the game certificate issuance unit 140, occurrence of the events is informed to an accumulation-type game service provider, and the user is confirmed through the signature and the certification information to receive the reserve money according to the occurrence of the events at a certain ratio.

In addition, the accumulation-type game server connection unit 150 is configured to form a gateway connected to the accumulation-type game server S on the communication network to transmit the certification information such as the reserve money input through the reserve money reception unit, the resident registration number of the golfer, and so on, to the accumulation-type game server S in real time.

Here, the accumulation-type game server connection unit 150 may be configured to continually receive information on the reserve money accumulated by the accumulation-type game using the accumulation-type game console from the accumulation-type game server S and the reserve money accumulated in another accumulation-type game console, and display the information to a display panel installed at the accumulation-type game console 100.

In addition, the accumulation-type game server connection unit 150 is configured to transmit the game selection signal of the accumulation-type game user, the reserve money input signal, and the certification information of the golfer to the game certification management server 300, receive the serial number of the accumulation-type game generated in the game certification management server 300, and output the information to the game certificate issuance unit 140.

Accordingly, the certification information of the golfer and the identification number of the accumulation-type game console transmitted through the accumulation-type game server connection unit are matched with the serial number received from the game certification management server 300.

In addition, a display panel configured to display the information of the accumulated reserve money and an advertisement panel to which various advertisement contents can be attached may be further provided at the accumulation-type game console.

The accumulated reserve money computation server 200 includes a reserve money computation unit 210 connected to the accumulation-type game server connection unit 150 and configured to receive the input signal of the basic reserve money input into the reserve money reception unit 120 on the communication network to update and store the reserve money accumulated in the corresponding accumulation-type game console, and a financial institution connection unit 220 configured to transmit a sum of the accumulated reserve money of the accumulation-type game console to a financial institution and deposit the sum.

Here, the reserve money computation unit 210 may be configured to receive the input signal of the basic reserve money and update the accumulated reserve money of the corresponding accumulation-type game console whenever the basic reserve money is input into the reserve money reception unit 120 installed at the accumulation-type game console. In addition, the accumulation-type game console is configured to autonomously compute and increase the accumulated reserve money to which the basic reserve money input into the corresponding reserve money reception unit is added, but the reserve money computation unit 210 may be configured to receive the input signal of the reserve money input into the accumulation-type game console per a certain time or a day and compute and update a totally accumulated reserve money input into the corresponding accumulation-type game console.

A ranking according to the accumulated reserve money updated according to the accumulation-type game consoles in the reserve money computation unit 210 can be checked on the communication network through a homepage managed by the service provider.

In addition, the financial institution connection unit 220 may be configured to be connected to a financial server of a bank, an agricultural cooperative federation, or a post office, transmit the sum corresponding to the accumulated reserve money input into the accumulation-type game console to the financial institution, and deposit the sum, so that the accumulated reserve money can be safely stored for a long time until an event such as a hole-in-one, albatross, cycling birdie, or eagle, which is set to pay the reserve money occurs, and the reserve money can be securely paid according to the following occurrence of the events.

Here, the accumulated reserve money deposited in the financial institution may be separately deposited according to the accumulation-type game consoles such that the payment can be stably performed according to the accumulation-type game consoles upon occurrence of the following events.

The game certification management server 300 includes a serial number generation unit 310 configured to generate a serial number that can identify a specific accumulation-type game performed through the golf game selected by the accumulation-type game console 100 from another accumulation-type game performed through another golf game and transmit the serial number to the accumulation-type game console 100, and a game result reception unit 320 configured to receive the result of the golf game written in the game certificate issued with the serial number and determine whether the event set in the accumulation-type game occurs.

Here, the serial numbers generated by the serial number generation unit 310 should be differently applied to the accumulation-type game consoles and the golf games performed in the accumulation-type game consoles. For example, characters representing places at which the golf game is performed, for example, C (country club), S (screen golf game room), P (par-three hole), and so on, identification numbers of various accumulation-type game consoles installed at the country club or the screen golf game room, and issuance numbers of the game certificates issued from the accumulation-type game consoles may be combined to generate the serial numbers such as C0001-0001, S0001-0001, or P0001-0001. However, the serial numbers generated by the serial number generation unit are not limited thereto but may be variously applied.

In addition, the serial number generation unit 310 may be configured to generate and transmit a new serial number whenever a game selection signal is input from the accumulation-type game console 100, apply only the characters representing the place and the identification number of the accumulation-type game console from the serial number generation unit 310, sequentially number issuance numbers of the game certificates from the game certificate issuance unit 140 installed at the accumulation-type game console, and transmit the serial numbers to the serial number generation unit 310 and store the serial numbers.

The game result reception unit 320 is configured to check whether the events occur by the result of the golf game written on the game certificate to determine payment of the reserve money, and pay the reserve money to the user written on the game certificate of the accumulation-type game in which the events occur at a certain ratio.

Here, the game result reception unit 320 may be configured to determine occurrence of the events for only the users who participate in the accumulation-type game and play the golf game using the same accumulation-type game console, or may be configured to determine occurrence of the events for all of the users who participate the accumulation-type game and play the golf game using all of the accumulation-type game consoles registered in the accumulation-type game server S.

In addition, the game result reception unit 320 may be configured to determine occurrence of the events only in the golf games performed in the same condition, for example, occurrence of the events in the golf games belonging to only the accumulation-type game consoles installed at the screen golf game room, occurrence of the events in the golf games belonging to only the accumulation-type game consoles installed at the country club, and so on.

Further, the game result reception unit 320 may be configured to determine occurrence of the events of all of the golf games performed for a certain time such as a day or a week to prevent initializing the accumulated reserve money due to occurrence of the events by other people before the golf game is finished after participating in the accumulation-type game.

When the events do not occur even in all of the golf games performed by a day or a week, the accumulated reserve money is accumulated to receive the accumulated reserve money larger than that when the following event occurs.

The accumulated reserve money calculation server 400 is configured to pay the reserve money accumulated in the accumulation-type game console 100 to the user who has the game certificate and the individual certification information coinciding therewith when it is determined that the events occur in the game certification management server, and then, initialize the reserve money accumulated in the corresponding accumulation-type game console 100.

Here, the accumulated reserve money calculation server 400 may be set to initialize the reserve money accumulated in the accumulation-type game console to zero, or may be variously set the initialized reserve money to 100,000 Won (about $100), 200,000 Won (about $200), or the like, in order to increase interest of the user who first participates in the accumulation-type game.

In addition, the accumulated reserve money calculation server 400 may be configured to initialize the accumulated reserve money stored in the accumulated reserve money computation server by the identification number of the accumulation-type game console in which the events occur, and transmit the accumulated reserve money information, which is initialized as described above, to the accumulation-type game console and the financial institution server and initialize the information.

The game setting server 500 is configured to set the events for paying the reserve money according to the result of the golf game and store the events. Here, the game setting server 500 may be configured to set the events that can be accomplished by an individual golfer during the golf game offline, for example, a hole-in-one, albatross, cycling birdie, or eagle, rather than a simple victory or defeat, such that many golfers can participate in the accumulation-type game under the same condition while performing different golf games. In addition, the game setting server may be differently set a distribution ratio of the accumulated reserve money according to probability of occurrence of the events.

Hereinafter, practice of the accumulation-type game using the accumulation-type game service system using the offline golf game of the present invention having the above-mentioned configuration will be described.

First, golfers who want to play the golf game visit the screen golf game room or the country club or make a reservation of the golf game. Here, since the accumulation-type game can be performed with the golf game at the place at which the accumulation-type game console 100 is installed, general golfers prefers the golf clubs, at which the accumulation-type game console is installed, rather than general golf clubs, at which the accumulation-type game console is not installed, upon booking the golf game.

Then, the golfers manipulates the game selection unit 110 installed at the accumulation-type game console, selects a kind of golf game performed offline, for example, an individual game or a team game, and inputs the number of golfers who participate in the golf game before playing the golf game.

Next, when the basic reserve money (for example, 1,000 Won (about $1) per each person) corresponding to the number of golfers is input into the reserve money reception unit 120 installed at the accumulation-type game console and the certification information that enables individual identification such as resident registration numbers or mobile phone numbers of the golfers who participate in the offline golf game is input, the golfer certification unit 130 installed at the accumulation-type game console receives the information, and then, the certification information of the golfer and the identification number of the accumulation-type game console are matched with the serial number received from the game certification management server 300 and stored therein.

In addition, when the golfer previously subscribes the accumulation-type game service according to the present invention and pays a certain amount of basic reserve money in advance, the basic reserve money is automatically withdrawn once by inputting the identification and password input upon membership application and the golfer can participate in the accumulation-type game. Here, the basic reserve money may be automatically withdrawn, and the certification information that can identify the individual can be automatically matched with the serial number and the identification number.

Here, the accumulation-type game server connection unit 150 installed at the accumulation-type game console transmits the serial number, the certification information, and the identification number to the accumulated reserve money computation server 200 and the game certification management server 300 through the communication network to store them as information related to the accumulation-type game to which the corresponding serial number is applied.

Then, the game certificate issuance unit 140 installed at the accumulation-type game console issues the game certificate on which the serial number, the identification number, the certification information, the date, the time, the kind of golf game, the result of the golf game, and so on, are printed.

The golfers play the golf game offline with carrying the game certificate and write the number of strokes in the golf game and occurrence of events such as a hole-in-one, albatross, cycling birdie, eagle, and so on.

In addition, the records of the golf game written as described above are confirmed by a manager of the screen golf game room or a caddie of the country club who observes the golf game, and occurrence of the events is transmitted to the game certification management server.

The game certification management server 300 checks occurrence of the events such as a hole-in-one, albatross, cycling birdie, eagle, or the like, based on the result of the golf game written in the game certificate, and pays the accumulated reserve money to the golfer, which is the user of the accumulation-type game, according to the ratio set by the game setting server when occurrence of the events is confirmed.

After payment of the accumulated reserve money, the accumulated reserve money calculation server 400 initializes the reserve money accumulated in the accumulation-type game console so that the next accumulation-type game can be performed.

As the small basic reserve money is input into the golf game performed offline and reward of the events such as a hole-in-one or the like intermittently occurring during the golf game is provided regardless of victory or defeat of the golf game, interest in the golf game can be increased while reducing a gambling aspect of golf betting.

While the invention has been shown and described with reference to certain example embodiments thereof, it will be understood by those skilled in the art that various changes in form and details may be made therein without departing from the spirit and scope of the invention as defined by the appended claims.

### REFERENCE SIGNS LIST

100: accumulation-type game console
110: game selection unit
120: reserve money reception unit
130: golfer certification unit
140: game certificate issuance unit
150: accumulation-type game server connection unit
200: accumulated reserve money computation server
210: reserve money computation unit
220: financial institution connection unit
300: game certification management server
310: serial number generation unit 320: game result reception unit
400: accumulated reserve money calculation server
500: game setting server

1. An accumulation-type game service system using an offline golf game comprising:
an accumulation-type game console installed at a place at which a golf game is performed and configured to issue a game certificate in which a user who wants to play an accumulation-type game is able to record a result of the golf game;
an accumulated reserve money computation server connected to the accumulation-type game console on a communication network and configured to compute an accumulated value of reserve money accumulated through the accumulation-type game console by the user;
a game certification management server configured to generate and transmit a serial number written in the game certificate issued from the accumulation-type game console, receive the result of the golf game performed offline, and determine whether events for payment of the reserve money occur;
an accumulated reserve money calculation server configured to pay the reserve money accumulated in the accumulation-type game console and initialize the accumulated reserve money of the accumulation-type game console when the game certification management server determines that the events occur; and
a game setting server configured to differentially set game events for payment of the reserve money and a ratio of the reserve money to be paid according to occurrence of the game events.

2. The accumulation-type game service system using the offline golf game according to claim 1, wherein the accumulation-type game console comprises:
a game selection unit configured to select a golf game to be played by golfers;
a reserve money reception unit configured to receive a small basic reserve money input according to a kind of golf game selected by the game selection unit;
a golfer certification unit configured to receive personal information for individual certification of a golfer who plays the golf game;
a game certificate issuance unit configured to issue a game certificate to which a serial number is applied such that the golfer who inputs the basic reserve money is able to write a result of the golf game performed offline; and
an accumulation-type game server connection unit connected to an accumulation-type game server to form a communication path to transmit and receive data on the communication network.

3. The accumulation-type game service system using the offline golf game according to claim 2, wherein the game certificate issuance unit comprises a printer configured to print and output the game certificate in which a serial number of the accumulation-type game matched with the certification information of the golfer input through the golfer certification unit, a date and a time at which the golf game is performed, a kind of golf game selected by the game selection unit, certification information for certifying the golfer after that, and a result description box in which a result of the golf game and occurrence of events can be written are printed.

4. The accumulation-type game service system using the offline golf game according to claim 3, wherein the serial number is configured to be matched with the certification information of the golfer and the identification number of the accumulation-type game console and stored.

5. The accumulation-type game service system using the offline golf game according to claim 3, wherein the accumulated reserve money computation server comprises:
a reserve money computation unit connected to the accumulation-type game server connection unit and configured to receive an input signal of a basic reserve money input into the reserve money reception unit on the communication network and update and store the reserve money accumulated in the accumulation-type game console; and
a financial institution connection unit configured to transmit a sum of the reserve money accumulated in the accumulation-type game console to a financial institution and deposit the sum.

6. The accumulation-type game service system using the offline golf game according to claim 5, wherein the accumulation-type game console is configured to autonomously compute and increase the accumulated reserve money to which the basic reserve money input into the reserve money computation unit is added in real time, and the reserve money computation unit is configured to receive an input signal of the total reserve money input into the accumulation-type game console per a certain time or a day and compute and update the total accumulated reserve money input into the accumulation-type game console.

7. The accumulation-type game service system using the offline golf game according to claim 6, wherein a ranking according to a situation of the accumulated reserve money updated according to the accumulation-type game console in the reserve money computation unit is able to be checked on the communication network through a homepage managed by a service provider.

8. The accumulation-type game service system using the offline golf game according to claim 5, wherein the game certification management server comprises:
a serial number generation unit configured to generate a serial number capable of identifying a specific accumulation-type game performed through the golf game selected by the accumulation-type game console from another accumulation-type game performed by another golf game to transmit the serial number to the accumulation-type game console; and
a game result reception unit configured to receive the result of the golf game written in the game certificate with the serial number and determine whether the events set by the accumulation-type game occur.
